(19) United States
(12) Patent Application Publication
(10) Pub. No.: US 2025/0092299 A1
(43) Pub. Date: Mar. 20, 2025

(54) DERIVATIZATION OF AMINES FOR USE AS SHALE INHIBITORS IN A SUBTERRANEAN FORMATION

(71) Applicant: Schlumberger Technology Corporation, Sugar Land, TX (US)

(72) Inventors: Dimitri M. Khramov, Katy, TX (US); Evgeny Barmatov, Cambridge (GB)

(21) Appl. No.: 18/725,550

(22) PCT Filed: Mar. 30, 2023
(86) PCT No.: PCT/US2023/016891

§ 371 Date: Jun. 28, 2024

Related U.S. Application Data
(60) Provisional application No. 63/362,174, filed on Mar. 30, 2022.

(51) Int. Cl. C09K 8/12; C09K 8/035

(52) U.S. Cl. CPC C09K 8/12; C09K 8/035; C09K 2208/12

(57) ABSTRACT

Method for the derivatization of a shale inhibitor comprising treating the amine-based shale inhibitor agents with at least one acid anhydride, and/or at least one organic acid, and/or at least one acyl chloride, thereby producing a derivatized amine shale inhibitor and using the derivative amine shale inhibitor to treat a subterranean formation in a wellbore to prevent reactive shale swelling.

### CROSS-REFERENCE TO RELATED APPLICATIONS

This application claims the benefit of U.S. Provisional Application No. 63/362,174, entitled “DERIVATIZATION OF AMINES FOR USE AS SHALE INHIBITORS IN A SUBTERRANEAN FORMATION,” filed Mar. 30, 2022, the disclosure of which is hereby incorporated herein by reference.

This application is also related to U.S. Patent Application 63/249,666 filed Sep. 29, 2021, and titled “SHALE INHIBITOR ADDITIVES, WELLBORE FLUIDS COMPRISING SAID ADDITIVES, AND METHODS OF USING SAID FLUIDS.” The foregoing application is expressly incorporated herein by this reference in its entirety.

### FIELD OF THE DISCLOSURE

The disclosure generally relates to methods for the derivatization of a shale inhibitor comprising treating the amine-based shale inhibitor agents with aqueous base fluids thereby producing a derivatized amine shale inhibitor. The disclosure also relates to using the derivatize amine shale inhibitor to treat a subterranean formation in a wellbore.

### BACKGROUND

The statements in this section merely provide background information related to the present disclosure and do not constitute prior art.

Wellbores are formed within or drilled into subterranean formations to recover hydrocarbons trapped within the subterranean formations. Subterranean formations may be at least partly composed of clays, including shales, mudstones, siltstones, and claystones.

Many problems may occur during the process of drilling into the subterranean formations. One major problem which may arise is the swelling of the wellbore in the presence of water. This process occurs when the subterranean formation absorbs water from the wellbore fluids, which are water-based drilling fluids or muds (hereinafter “WBM”), contained in the wellbore. This issue can be exacerbated as the water content of the wellbore fluid or WBM increases due to the formation's hydration in the aqueous environment. This occurrence can increase drilling times and/or costs associate with the wellbore drilling operations.

Amines can be incorporated into drilling fluids to produce high performance water-based drilling fluids to prevent swelling of the wellbore in the subterranean formation. Amines may act as an inhibitor for reactive shale swelling. In particular, the hydrophobicity of an amine plays a role in the amine performance as a shale inhibitor.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one or more embodiments, a method of formulating a shale inhibitor may include a polyamine of a Formula (I):

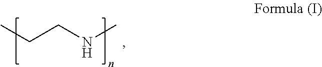

wherein n may be a polymer of repeating units including an amine group and two carbon aliphatic CH₂CH₂ spacers. Further, treating Formula (I) with at least one acid anhydride, and/or at least one organic acid, and/or at least one acyl chloride, thereby producing a derivatized amine shale inhibitor.

In an embodiment, the at least one acid anhydride may be added dropwise to Formula (I) in a flask at ambient temperature to produce a reaction. Further, the reaction may be neutralized.

In an embodiment, the at least one organic acid may be added dropwise to Formula (I) in a flask at temperatures between 80° C.-150° C. to produce a reaction. Further the reaction may be neutralized.

In an embodiment, the at least one acyl chloride may be added dropwise to Formula (I) in a flask at ambient temperature to produce a reaction. Further the reaction may be neutralized.

In an embodiment, the polyamine may include one or more diamines, one or more triamines, one or more polyamines, and/or mixtures thereof.

In an embodiment, the polyamine may include one or more linear molecules, one or more non-linear or branched molecules, or mixtures thereof.

In an embodiment, the n may be an integer from 2-100.

In an embodiment, the at least one acid anhydride may include at least one of acetic anhydride, propionic anhydride, and at least one mixture thereof.

In an embodiment, the acid anhydride may further include a cyclic anhydride of at least one of succinic anhydride, maleic anhydride, phthalic anhydride, or glutaric anhydride.

In an embodiment, the cyclic anhydride may produce a reaction product having amide bonds and pendant acid groups.

In an embodiment, the reaction product may be utilized as both a shale inhibitor and shale encapsulator.

In an embodiment, the at least one organic acid may include at least one carbon atom to fifty four carbon atoms.

In an embodiment, the at least one organic acid may include carboxylic acids, aliphatic acids, aromatic acids, or at least one mixture thereof.

In an embodiment, the one or more polyamines may be derivatized to at least about 10 mol % derivatized, at least about 30 mol % derivatized, or up to about 50 mol % derivatized.

In an embodiment, the polyamine may be methylated using alkylating agents.

In an embodiment, the alkylating agents may include methyl chloride and/or methyl sulfate.

In an embodiment, the polyamine may be methylated with at least one Eschweiler-Clarke methylation or reaction.

In an embodiment, the polyamine may be methylated by reacting the polyamine with a mixture of formaldehyde and formic acid.

In an embodiment, the polyamine may be alkylated or arylated by reacting the polyamine with alkane molecules, aryl molecules, or a mixture thereof.

In one or more embodiments, the derivatize amine shale inhibitor may be used to treat a subterranean formation in a wellbore.

In one embodiment, the derivatize amine shale inhibitor may be used to treat a subterranean formation in a wellbore to prevent reactive shale swelling.

In one embodiment, a wellbore fluid, may include: a base fluid, a shale inhibitor including: a polyamine of a Formula (I):

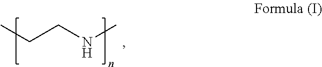

wherein n may be a polymer of repeating units including an amine group and two carbon aliphatic CH₂CH₂ spacers; treating Formula (I) with at least one acid anhydride, and/or at least one organic acid, and/or at least one acyl chloride.

In an embodiment, the base fluid may be an aqueous base fluid including acid anhydride, organic acid, and/or acyl chloride.

In an embodiment, the polyamine may include one or more diamines, one or more triamines, one or more polyamines, and/or mixtures thereof.

In an embodiment, the polyamine may include one or more linear molecules, one or more non-linear or branched molecules, or mixtures thereof.

In an embodiment, n may be an integer from 2-100.

In an embodiment, the at least one acid anhydride may include at least one of acetic anhydride, propionic anhydride, and at least one mixture thereof.

In an embodiment, the acid anhydride may further include a cyclic anhydride of at least one of succinic anhydride, maleic anhydride, phthalic anhydride, or glutaric anhydride.

In an embodiment, the cyclic anhydride may produce a reaction product having amide bonds and pendant acid groups.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

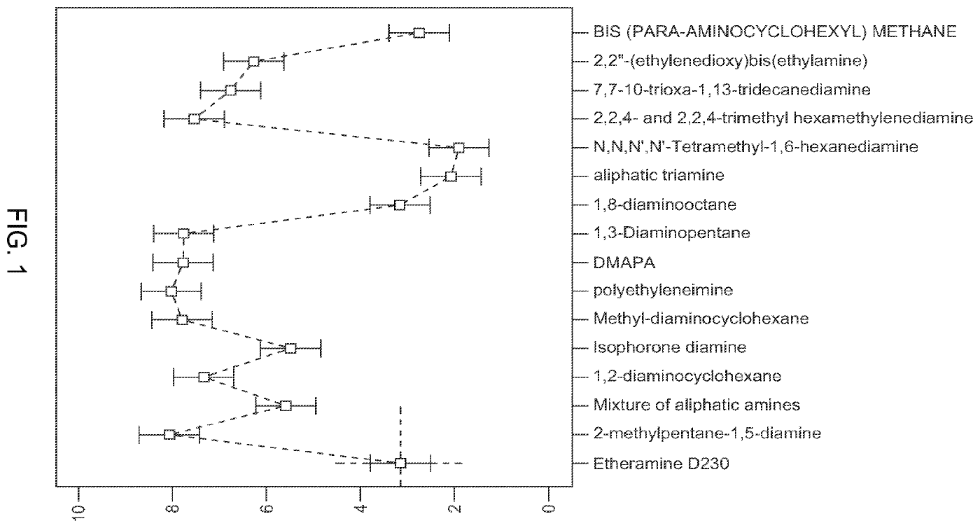

(FIG. 1) DOE Analysis for bulk hardness test for Arne clay.

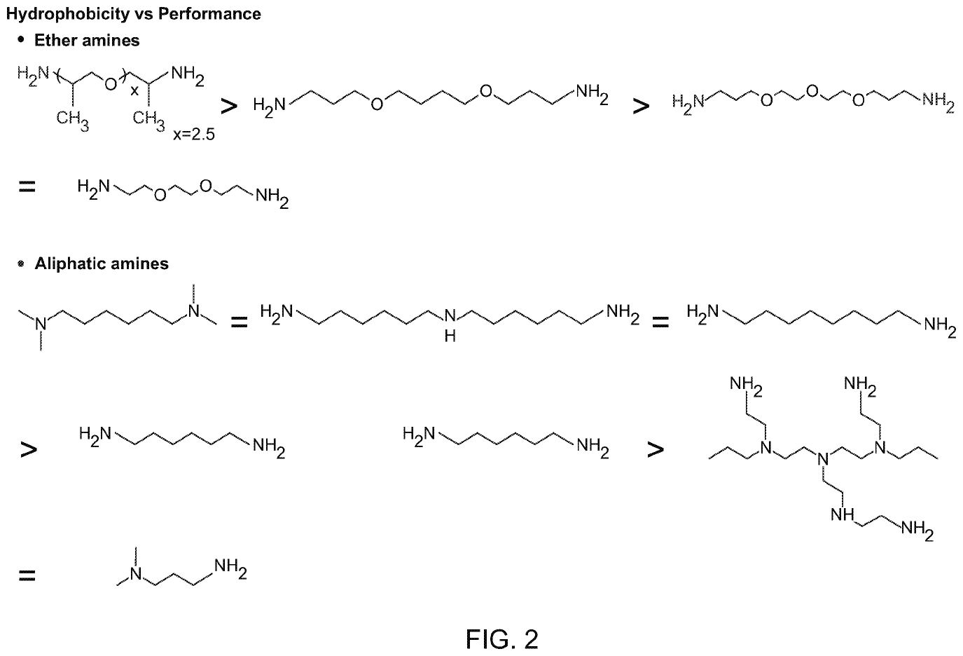

(FIG. 2) Structure activity analysis for the hydrophobic vs hydrophilic nature of shale inhibitor.

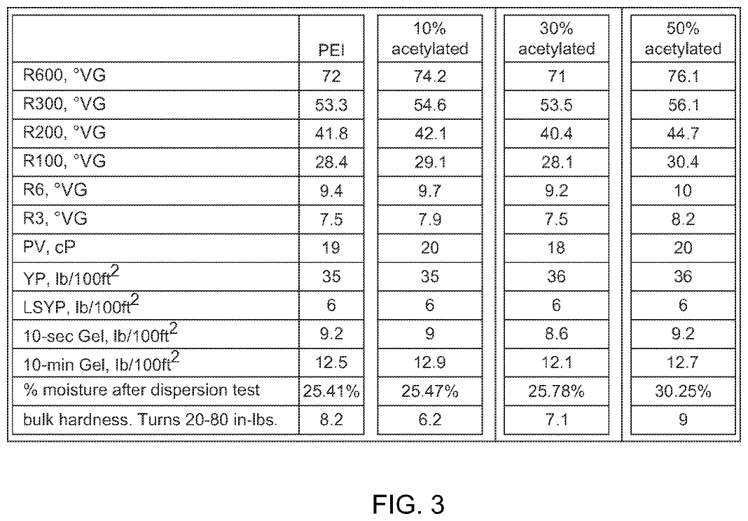

(FIG. 3) Rheology and clay properties (Arne 4-6 mm) of derivatized Polyethyleneimine (PEI).

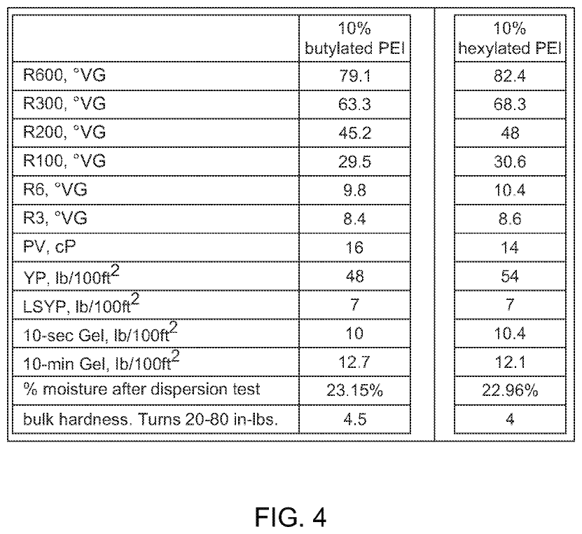

(FIG. 4) Testing results with PEI derivatized using 10 mol % butyric or 10% mol hexanoic anhydrides.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” As used herein, the phrases “selected from the group consisting of,” “chosen from,” and the like include mixtures of the specified compounds and/or materials. Terms, such as, for example, “contains” and the like are meant to include “including at least” unless otherwise specifically noted.

Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Where a numerical limit or range is stated, the endpoints are included. Also, all values and subranges within a numerical limit or range are specifically included as if explicitly written out. Moreover, examples herein are intended to be illustrative only and are presented for discussion purposes and not by way of limitation. Methods for the derivatization of a shale inhibitor comprising treating the amine-based shale inhibitor agents thereby producing a derivatized amine shale inhibitor

Embodiments disclosed herein relate to the derivatization of amines with aqueous base fluids for use as a shale inhibitor that may be incorporated into wellbore fluids for use in drilling at least one well or wellbore (collectively referred to hereinafter as “wellbore”) through a subterranean formation including at least one shale that swells in the presence of water. Derivatized amines in accordance with the present disclosure may be formulated to promote retention of the wellbore fluids within the wellbore and prevent fluid loss due to absorption by clays and other hydrophilic minerals. In one or more embodiments, the amines disclosed herein may include a polyamine, and the aqueous base fluids disclosed herein may include at least one acid anhydride, and/or at least one organic acid, and/or at least one acyl chloride.

### Inhibition of Shale

During the drilling of a subterranean wellbore, one or more negative clay-fluid interactions may have adverse impacts on the wellbore drilling operations. In one or more embodiments, the one or more negative clay-fluid interactions may include at least clay swelling during the wellbore drilling operations. For example, an overall increase in bulk volume accompanying clay swelling may impede removal of cuttings from beneath the drill bit, may increase friction between the drill string and the sides of the borehole, and/or may inhibit formation of the thin filter cake that seals formations. Clay swelling may also create one or more additional drilling problems, such as, for example, loss of circulation or stuck pipe that slows wellbore drilling operations and increases wellbore drilling costs.

Clay minerals encountered in subterranean formations are often crystalline in nature, which may dictate the response observed when exposed to the drilling fluids disclosed herein. Clays may have a flaky, mica-type structure made up of crystal platelets stacked face-to-face. Each platelet is called a unit layer, and the surfaces of the unit layer are called basal surfaces. Each unit layer is composed of multiple sheets, which may include octahedral sheets and tetrahedral sheets. Octahedral sheets are composed of either aluminum or magnesium atoms octahedrally coordinated with the oxygen atoms of hydroxyls, whereas tetrahedral sheets contain silicon atoms tetrahedrally coordinated with oxygen atoms.

In clay mineral crystals, atoms having different valences may be positioned within the sheets of the structure to create a negative potential at the crystal surface, which causes cations to be adsorbed thereto. These adsorbed cations are called exchangeable cations because they may chemically trade places with other cations when the clay crystal is suspended in water. In addition, ions may also be adsorbed on the clay crystal edges and exchange with other ions in the water.

The clay crystal structure and the exchangeable cations adsorbed on the crystal surface may affect clay swelling. Clay swelling is the phenomenon in which water molecules surround a clay crystal structure and position themselves to increase the d-spacing of the structure, which results in a measurable increase in volume. Two types of swelling may occur: surface hydration; and osmotic swelling.

Surface hydration is one type of swelling in which water molecules are adsorbed on crystal surfaces. Hydrogen bonding holds a layer of water molecules to the oxygen atoms exposed on the crystal surfaces. Subsequent layers of water molecules align to form a quasi-crystalline structure between unit layers, which results in an increased d-spacing. Additional swelling may occur when water penetrates between layers of non-swelling clays, such as, for example, barite.

Osmotic swelling is a second type of swelling, wherein the concentration of cations between unit layers in a clay mineral is higher than the cation concentration in the surrounding water. As a result, water is osmotically drawn between the unit layers and the d-spacing is increased. Osmotic swelling results in larger overall volume increases than surface hydration. However, only certain clays, such as, for example, sodium montmorillonite swell in this manner.

In one or more embodiments, clay swelling is inhibited through derivatized amines and other wellbore fluids disclosed herein which reduce the aforementioned drawbacks of conducting operations in clay-containing subterranean formations. The derivatization of the amine disclosed herein may be accomplished by one or more polyamines and the addition of one or more of an aqueous base fluid including acid anhydrides, organic acids, and/or acyl chlorides along with one or more wellbore fluid additives dependent upon the particular operations and/or applications.

### Derivatization of Amine

In one or more embodiments, the amine disclosed herein may include one or more polyamines. The one or more polyamines may be, for example, one or more derivatized amine-based inhibition agents. The one or more derivatized inhibition agents may be efficient shale inhibitors and comprise one or more oligomeric amines, one or more hydrophobic amines, and/or one or more mixtures thereof. The inhibition agents may be one or more amines that may be both oligomeric and hydrophobic amines. Amines having increased or improved hydrophobicity provide advantageous structure-activity when utilized as the one or more derivatized amine-based inhibition agents. However, amines that exhibit too high of hydrophobicity may not be as advantageous because such amines may not be dissolvable in water. The inhibition agents disclosed herein may be present in the wellbore fluids at a concentration of about 0.5 to about 4 vol. %, about 1 to about 3 vol. %, or about 1.5 to about 2.5 vol. %, wherein all volume percentages are calculated to total volumes of the wellbore fluids. In some embodiments, the concentration of the inhibition agents may be less than about 0.5 vol. % or greater than about 4 vol. %, wherein all volume percentages are calculated to total volumes of the wellbore fluids.

In some embodiments, the one or more oligomeric amines may include one or more diamines, one or more triamines, one or more polyamines, and/or a mixture thereof. For example, polyamines may include polymers and copolymers prepared from amine functionalized monomers such as vinyl amine, ethylene imine, and the like. The general structure of a polyamine is:

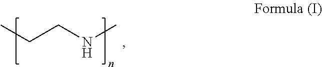

wherein n is a polymer of repeating units comprising an amine group and two carbon aliphatic CH₂CH₂ spacers. In some embodiments polyamines may include small molecule nuclei and oligomer polyamines including diethanolamine, trithanolamine. diethylenetriamine (DETA), triethylenetetramine (TETA), tetraethylenepentamine (TEPA). pentaethylenehexamine (PEHA), and other polyethylene polyamines; Oligomers of 1,3-diaminopropane, 1,4-diaminobutane, 1,5-diaminopentane, putrescine, cadaverine, spermidine, spermine, thermospermine, caldopentamine, and caldohexamine; linear or branched organophilic C2-C54 fatty polyamines including alkyl diamines, polyether diamine, polyaliphatic polyamines, heterocyclic polyamines, alkylalkanol polyamines. polyethertriamines and polyethyleneimine non-limiting examples of which may include maleic anhydride homopolymers and copolymers grafted with fatty amines, and styrene methacrylate-graft-polyethyleneimine; and polymerized amino acids with pendant amine groups such as poly(lysine).

In some embodiments polyamines include Baxxodur EC 210, Baxxodur EC 201, Berolamine BA-20, HMD (DAM 700, DAM800), DCH (DAM 950), Tertamethyl-HMD, Dytek A, Dytek EP, DMAPA, etheramine D230, Vestamin PACM. BHMT, 1,8-diamine, Vestamin TMD, 1.8-diaminooctane, 2,2″-(ethylenedioxy)bis(ethylamine), 7,7-10-trioxa-1,13-tridecanediamine, Bis(hexamethylene)triamine, N,N,N′,N′-Tetramethyl-1,6-hexanediamine, and 4,4′-Diaminodicyclohexylmethane. In at least one embodiment, the one or more oligomeric amines may include one or more cyclic amines.

In one or more embodiments, the inhibition agents may include one or more polyamines that have been derivatized with at least one acid anhydride and/or at least one organic acid or at least one inorganic acid. For example, the at least one acid anhydride may be at least one of acetic anhydride, propionic anhydride, and at least one mixture thereof. Further, the at least one acid anhydride may include at least one of formic acid, acetic acid, propionic acid, butyric acid, valeric acid, caproic acid, enanthic acid. caprylic acid, pelargonic acid, capric acid. undecylic acid, lauric acid, tridecylic acid. myristic acid, pentadecylic acid, palmitic acid, margaric acid, stearic acid, nonadecylic acid, arachidic acid, or at least one mixture, thereof.

The at least one organic acid may include at least one (1) carbon atom and not more than about one hundred carbon atoms (100) carbon atoms or at least one mixture of said organic acids.

The at least one inorganic acid may include phosphoric acid and derivatives of phosphoric acid with alkyl groups that can react to make an amide such as tributylphosphate, mono- and d-butylphosphate and other phosphates with full or partial alkyl group substitutions which can tune hydrophobicity. Other types of inorganic acids with or without alkyl/aryl substitution (full or partial) groups based on phosphorus such as phosphonic or phosphonic acids are suitable. Similarly sulfuric acid and sulfate esters can be used to make an amide and further tune hydrophobicity by using different substituents on sulfate ester.

The derivatization of the one or more polyamines may be at least about 10 mol % derivatized, at least about 30 mol % derivatized, or up to about 50 mol % derivatized based on total content of free amines. In other embodiments, the inhibition agents may be one or more polyamines treated with at least one cyclic anhydride which may produce a reaction product having amide bonds and pendant acid groups. The reaction product may be utilized as both an efficient a shale inhibitor and shale encapsulator. The at least one cyclic anhydride may be, for example, maleic anhydride, succinic anhydride, itaconic anhydride, phthalic anhydride, glutaric anhydride, tetrahydrophthalic anhydride, hexahydrophthalic anhydride, chlorendic anhydride. trimellitic anhydride, pyromellitic anhydride, tetracarboxylic acid anhydride biphenyltetracarboxylic acid anhydride or alkyl-succinic anhydride.

In some embodiments, hydrophobicility of the amines may be improved or increased by one or more methylation methods. Methylation methods may be advantageous because the resulting functionality is still an amine that can bind to clay. Acetylation converts amines into amides which are not bondable to clay by cation exchange. Methylation keeps amines available for bonding, but methylation increases hydrophobicity of the resulting amines. In some embodiments, methylation may be carried out with one or more typical alkylating agents, such as, for example, methyl chloride, methyl sulfate, and/or similar alkylating agents, or by reacting with a mixture of formaldehyde and formic acid. In one embodiment, the one or more methylation methods may include at least one Eschweiler-Clarke methylation or reaction.

In embodiments, inhibition agents of the inhibition additives disclosed herein may include one or more linear molecules, one or more non-linear or branched molecules, or mixtures thereof. The inhibition agents may have, but are not limited to, molecular formulas comprising at least 2 nitrogen atoms or at least 3 nitrogen atoms and/or at least 6 carbon atoms, at least 8 carbon atoms. at least 10 carbon atoms, at least 12 carbon atoms, or no more than 15 carbon atoms. Additionally. the inhibition agents of the derivatized amines disclosed herein may have, but are not limited to, molecular masses of at least about 110, at least about 115, at least about 140, at least about 170, at least about 200, or no more than about 220. Further, the inhibition agents of the derivatized amines disclosed herein may have, but are not limited to, boiling points of about 92° C., at least about 205° C. at least about 210° C., at least about 220° C. or at least about 225° C. Still further, the inhibition agents of the derivatized amines disclosed herein may have, but are not limited to, densities of at least about 0.81 g/cm³, at least about 0.93 g/cm³, or no more than about 0.95 g/cm³.

In some embodiments, the inhibition agents of the derivatized amines may have elevated or high pKa values that may be at least partially protonated or entirely protonated such that the resulting partially or fully protonated inhibition agents have decrease smell and/or elevated or higher pH values. For example, the inhibition agents may have, but are not limited to, pKa values of about 8 to about 13, about 9 to about 12, or at least 10. In an embodiment, the inhibition agents may have, but are not limited to, pKa values over about 10. In other embodiments, a portion of the nitrogen atoms of the inhibition agents may be protonated at the pH of the wellbore fluid. For example, at least about 50% of the nitrogen atoms of the inhibition agents may be protonated at the pH of the wellbore fluid. The inhibition agents may have a quaternary nature that is directedly related to or based on at least one of the pKa value, the pH value, and/or the percentage of protonation. Said quaternary nature may allow the inhibition agents to participate in cation exchange with clay which provides stabilization of the clay. In some embodiment, quaternization may be achieved by alkylation of tertiary one or more nitrogens. The quat produced by alkylation is a so-called permanent charge which may reduce the importance of pH on a function of the inhibition agent.

In one or more embodiments, the derivatized amines disclosed herein comprises a triamine-based inhibition agent, a tetramer-based inhibition agent, and an optional diamine-based inhibition agent as shale inhibitors. The oligomers disclosed herein may be, but are not limited to, repeat units of a defined monomer which may include at least 2 or more carbon atoms. If the triamine-, tetramer-, and/or diamine-based inhibition agents are present as a blend in the derivatized amine, the triamine-, and/or the tetramer-based inhibition agent may surprisingly and unexpectedly exhibit improved performances when directly compared to the diamine-based inhibition agent and/or may surprisingly and unexpectedly exhibit improved stabilities across a plurality of pH values. In some embodiments, the derivatized amine may include one or more higher oligomers past or beyond triamine-and/or tetramer-based inhibition agents and/or the one or more higher oligomers may also surprisingly and unexpectedly exhibit improved performances and/or stabilities when directly compared to the diamine-, triamine-, and/or tetramer-based inhibition agents.

In one or more embodiments, the inhibition agents disclosed herein may be prepared from at least one amine stream. During preparation of the inhibition agents, the at least one amine stream may neutralize and/or formulated such that an amine content of the prepared inhibition agents may be about 30% by weight, about 35% by weight, about 40% by weight, about 45% by weight, or about 50% by weight, wherein all weight percentages are calculated to total weights of the inhibition additives. The remainder of the prepared derivatized amine may include one or more acids, water, and/or at least one aqueous-based fluid or solution. As a result, the prepared derivatized amine may exhibit acceptable or improved pH values and/or pour point values when the prepared derivatized amines are incorporated into or included within the wellbore fluids disclosed herein.

### Wellbore Fluid Additives

Wellbore fluid additives disclosed herein may include one or more rheological additives, one or more polymeric shale inhibitor additives, or at least one mixture thereof. For example, the one or more rheological additives may include one or more viscosifying agents, and the one or more polymeric shale inhibitor additives may include one or more encapsulating polymer agents. Other known wellbore fluid additives may be incorporated into the wellbore fluids disclosed herein as known to one of ordinary skill in the art.

The one or more viscosifying agents may alter or maintain the viscosity and potential changes in viscosity of the wellbore fluid. Viscosity control may be needed in some scenarios in which a subterranean formation contains varying temperature zones. For example, the wellbore fluid may undergo temperature extremes of nearly freezing temperatures to nearly the boiling temperature of water or higher as the wellbore fluid moves from the surface to the drill bit and back to the surface.

In one or more embodiments, the one or more viscosifying agents may be selected from one or more natural biopolymers that are usable in WBM. In embodiments, the one or more natural biopolymers may include starches, celluloses, and/or various gums, such as xanthan gum, diutan gum, gellan gum, welan gum, schleroglucan gum and/or at least one or more mixtures thereof. Said starches may include potato starch, corn starch, tapioca starch, wheat starch, rice starch, and/or at least one mixture thereof. In some embodiments, the one or more viscosifying agents may include at least one gum, such as, for, example, xanthan gum, diutan gum, or mixtures thereof. In accordance with various embodiments of the present disclosure, the one or more biopolymer viscosifying agents may be unmodified (i.e., without derivitization). In embodiments, the one or more viscosifying agents may include, for example, at least one of POLYPAC® UL polyanionic cellulose (PAC), DUOVIS®, and BIOVIS®, each available from M-I L.L.C. (Houston, TX.).

In some embodiments, one or more viscosifying agents may be one or more polymeric viscosifiers comprising synthetic polymers that resist degradation over time, and/or under high temperature/high pressure conditions. Thermal and pressure stable polymeric viscosifiers polymers may include polymers, copolymers, block copolymers. and higher order copolymers (i.e., a terpolymer or quaternary polymer, etc.) composed of monomers that may include 2-acrylamido-2-methylpropanesulfonate, acrylamide, methacrylamide, N,N dimethyl acrylamide, N,N dimethyl methacrylamide. tetrafluoroethylene, dimethylaminopropyl methacrylamide, N-vinyl-2-pyrrolidone. N-vinyl-3-methyl-2-pyrrolidone, N-vinyl-4,4-diethyl-2-pyrrolidone, 5-isobutyl-2-pyrrolidone, N-vinyl-3-methyl-2-pyrrolidone, alkyl oxazoline, poly(2-ethyl-2-oxazoline), C2-C12 olefins, ethylene, propylene. butene, butadiene, vinyl aromatics, styrene, alkylstyrene, acrylic acid, methacrylic acid, vinyl alcohol, partially hydrolyzed acrylamide or methacrylamide, derivatives thereof, and/or mixtures thereof. In yet other embodiments, polymeric viscosifiers may include polyalkylene amines and polyethers, such as, for example, polyethylene oxides, polypropylene oxide, and/or mixtures thereof.

In one or more embodiments, the polymeric viscosifiers may include, for example. thermally stable polymeric viscosifiers, such as, for example, DUROTHERM™, DURALON™, available from MI, L.L.C. (Houston, TX.), KEMSEAL™, available from Baker Hughes, Inc. (Houston, TX.), DRISCAL®-D, available from Phillips Petroleum Co. (Bartlesville, Olka), CYPAN™, available from National Oilwell Varco (Houston, TX.), and ALCOMER™ 242, available from Allied Colloids Ltd (United Kingdom). In other embodiments. the one or more viscosifying agents may be, for example, IDCAP™ D, available from MI L.L.C. (Houston, TX.).

In embodiments. the one or more viscosifying agents may include additional components comprising at least one organic compound. The additional components may be compounds comprising at least one aldehyde group or two aldehyde groups. For example, the at least one organic compound may be a dialdehyde, such as, for example. glyoxal.

The wellbore fluids disclosed herein may contain one or more viscosifying agents in an amount of about 0.5 to about 5 pounds per barrel (hereinafter “ppb”), about 0.25 to about 2 ppb, or up to about 4 ppb. However. the concentration ranges may be dependent upon, for example, particular wellbore diameters, annular velocities, cutting carrying capacities, and/or quiescent times expected or desired. The one or more viscosifying agents may have, but are not limited to, viscosities of about 1.2 to about 1.8 Pa*s or about 1.1 to about 1.9 Pa*s and a specific gravity of about 1.2 to about 1.8, about 1.4 to about 1.6, or about 1.5. In some embodiments, the amount of the one or more viscosifying agents may be less than about 0.5 ppb or greater than about 5 ppb and/or the viscosity may be less than about 1.2 Pa*s or greater than about 1.9 Pa*s.

In one or more embodiments, the wellbore fluids disclosed herein may include one or more encapsulating polymer agents that may form a viscous polymer coating, film, or barrier on, for example, cuttings and walls of the wellbores. The viscous polymer coating, film, or barrier may seal microfractures of the shale and/or slow diffusion of water molecules into the shale which may slow hydration and disintegration. In embodiments, the one or more encapsulating polymer agents may include at least one of one or more partially-hydrolyzed polyacrylamides, one or more acrylate polymers, one or more acrylate copolymers, and mixtures thereof. In an embodiment, the one or more encapsulating polymer agents may be acrylic acid copolymer encapsulators. The one or more encapsulating polymer agents may be present in the wellbore fluids at concentrations of about 1 kg/m³ to about 12 kg/m³, or no more than about 3 or about 4 vol. %, calculated to total volumes of the wellbore fluids. In embodiments, the one or more encapsulating polymer agents may have specific gravities of about 1.2 to about 1.8 or about 1.4 to about 1.6.

Moreover, the wellbore fluids disclosed herein may include weight materials or weighting agents to increase the densities of the wellbore fluids. The weighting materials or agents may increase the densities of the wellbore fluids so as to prevent kick-backs and blow-outs. Thus, the weighting materials or agents may be added to the wellbore fluids in functionally effective amounts largely dependent on the nature of the subterranean formations being drilled. Weighting agents or density materials usable in the wellbore fluids disclosed herein include galena, hematite, magnetite, iron oxides, illmenite. barite, siderite, celestite, dolomite, calcite, and the like, mixtures and combinations of these compounds and similar such weight materials that may be used in the formulations of the wellbore fluids. The quantity of such material added, if any, may depend upon the desired density of the final compositions of the wellbore fluids. In some instances, weighting agent is added to result in a drilling fluid density of up to about 24 ppg. The weighting agent may be added up to 21 ppg in some embodiments, and up to 19.5 ppg in other embodiments.

In some embodiments, other wellbore fluid additives may also include, for example, one or more thinners and/or one or more fluid loss control agents which may be optionally added to wellbore fluids disclosed herein. Of these additional materials, each may be added to the formulation in a concentration as rheologically and functionally required by wellbore drilling conditions and/or operations.

### Wellbore Fluids

Wellbore fluids disclosed herein may contain a base fluid that is entirely aqueous base or contains a full or partial oil-in-water emulsion. In some embodiments, the wellbore fluid may be any water-based fluid that is compatible with the inhibition additives and/or the inhibition agents disclosed herein. In some embodiments, the base fluid may include at least one of fresh water or mixtures of water and water soluble organic compounds.

In one or more embodiments, the wellbore fluids may contain a brine such as seawater, aqueous base fluids, or solutions wherein the salt concentration is less than that of sea water, or aqueous fluids or solutions wherein the salt concentration is greater than that of sea water. Salts that may be found in seawater include, but are not limited to, sodium, calcium, aluminum, magnesium, potassium, strontium, lithium, and salts of chlorides, bromides, carbonates, iodides, chlorates, bromates. formates, nitrates, oxides, sulfates, phosphates, silicates and fluorides. Salts that may be incorporated into given brines include any one or more of those present in natural seawater or any other organic or inorganic dissolved salts. Additionally, brines that may be used in the wellbore fluids disclosed herein may be natural or synthetic, with synthetic brines tending to be much simpler in constitution. One of ordinary skill would appreciate that the above salts may be present in the base fluids or may be added according to the methods disclosed herein. Further, the amount of the aqueous based continuous phase should be sufficient to form a water-based drilling fluid or mud (hereinafter “WBM”). This amount may range from nearly 100% of the wellbore fluids to less than about 30% of the wellbore fluids by volume. In some embodiments, the aqueous based continuous phase may constitute from about 95 to about 30% by volume or from about 90 to about 40% by volume of the wellbore fluids.

In some embodiments, the wellbore fluids disclosed herein may be high performance WBMs comprising the inhibition agents as inhibitor of reactive shale swelling. Prevention of shale swelling is key to WBM performance because wellbore integrity depends on inhibitive properties of WBM. Additionally, prevention of shale swelling and consequent reduction in shale dispersion reduces costs associate with the wellbore drilling processes by reducing the volumes of dilution needed to maintain acceptable viscosities for the WBMs. In embodiments, the high performance WBMs disclosed herein may include at least the aqueous base fluid, the polyamine (comprising the inhibition agents), the one or more viscosifying agents, and the one or more encapsulating polymer agents, and mixtures thereof. The wellbore fluids disclosed herein may have pH values of less than about 11.5, about 8.5 to about 11, about 9.0 to about 10.5, or about 9.5 to about 10.5.

In yet another embodiment, the wellbore fluids disclosed herein may be used alone or in combination with one or more conventional or additional additives. The additional additives, that may further be included in the present wellbore fluids, may include, for example, wetting agents, organophilic clays, additional viscosifiers, fluid loss control agents, surfactants, dispersants, interfacial tension reducers, pH buffers, mutual solvents, additional thinners, additional thinning agents, cleaning agents, or mixtures thereof. Inclusion of such additional additives in the present wellbore fluids should be well known to one of ordinary skill in the art of formulating wellbore fluids or WBMs.

In one or more embodiments, one or more surprising and unexpected synergies are achievable with wellbore fluids disclosed herein having pH values of about 8.5 to about 11 and comprising at least the aqueous base fluids, the one or more amine-based inhibition agents, and the one or more viscosifying agents. In other embodiments, one or more additional surprising and unexpected synergies are achievable with wellbore fluids disclosed herein having pH values of about 8.5 to about 11 and comprising at least the aqueous base fluids, the one or more amine-based inhibition agents, the one or more viscosifying agents, and one or more encapsulating polymer agents. In some embodiments, additional surprising and unexpected synergies are achievable with wellbore fluids disclosed herein having pH values of about 9 to about 10.5 and/or comprising triamine-based inhibition agents present at concentrations of at least about 50% or at least about 75% by weight, calculated to total weights of the derivatized amine.

In one or more embodiments, the methods disclosed herein may include providing, formulating, and/or mixing a wellbore fluid (e.g., a drilling fluid, reservoir drill-in fluid, fracturing fluid, etc.) that contains the aqueous base fluid, the polyamine, comprising the inhibition agents, the viscosifying agents, and/or the encapsulating polymer agents. In some embodiments, the methods disclosed herein may emplace, dispose. and/or provide the wellbore fluids within wellbores of subterranean formations. The above-mentioned agents may be mixed into the wellbore fluid individually or as a multi-component additive that contains the inhibition agents, the viscosifying agents, the encapsulating agents, and/or the additional additives. The above-mentioned agents and/or the additional additives may be added to the wellbore fluids prior to, during, or subsequent to emplacing or circulating the wellbore fluids in the subterranean formations.

The wellbore fluids disclosed herein may be used in methods for drilling wellbores into the subterranean formations in a manner similar to those wherein conventional wellbore fluids are used. In the methods of drilling, the wellbore fluid disclosed herein may be circulated through the drill pipe, through the bit, and up the annular space between the pipe and the formation or steel casing to the surface. The wellbore fluids disclosed herein may perform several different functions during the methods, such as, for example, cooling the bit, removing drilled cuttings from the bottom of the hole, suspending, coating, and/or encapsulating the cuttings, coating walls of the wellbore, and/or weighting the material within the wellbore when circulation is interrupted.

The inhibition agents, the viscosifying agents, the encapsulating agents, and/or the additional additives may be added to the base fluids on location at a well-site where it is to be used, or may carried out at other locations than the well-site. If the well-site location is selected for carrying out this step, the inhibition agents, the viscosifying agents, the encapsulating agents, and/or the additional additives may be dispersed in the base fluids, and the resulting wellbore fluids may be emplaced, disposed, and/or circulated in the wellbores using techniques known in the art.

In one or more embodiments, the components of the wellbore fluids disclosed herein (i.e., the aqueous base fluids, the inhibition agents, the viscosifying agents, the encapsulating agents, and/or the additional additives) may be added to the wellbores simultaneously or sequentially, depending on the demands of the downhole environments. In some embodiments, the wellbore fluids disclosed herein may be emplaced or provided into the wellbores before or after adding one or more preflush or overflush fluids.

In some embodiments, the methods disclosed herein may reduce the swelling of shale in the wellbores whereby the wellbore fluids disclosed herein are circulated in the wellbores. The methods and wellbore fluids disclosed herein may be utilized in a variety of subterranean operations that involve subterranean drilling, drilling-in (without displacement of the fluid for completion operations) and fracturing. Examples of suitable subterranean drilling operations include, but are not limited to, water well drilling, oil/gas well drilling, utilities drilling, tunneling, construction/installation of subterranean pipelines and service lines, and the like. In some embodiments, the methods and wellbore fluids disclosed herein may be used to stimulate the fluid production.

In other embodiments, the methods disclosed herein may circulate, provide, and/or dispose the present wellbore fluids in wellbores disposed within a clay-containing subterranean formations. The present wellbore fluids may have a pH value of about 8.5 to about 11 and/or comprise aqueous base fluids, the polyamine, at least one of the natural biopolymeric viscosifier agents, at least one of the encapsulating polymer agents, or mixtures thereof. The shale inhibition additives may include at least one hydrophobic amine-based shale inhibition agent and at least one oligomeric amine-based shale inhibition agent. the at least one hydrophobic amine-based shale inhibition agent may be the triamine-based shale inhibition agent, and/or the at least one oligomeric amine-based shale inhibition agent may be a diamine-based shale inhibition agent. The hydrophobic amine-based shale inhibition agents may be present at concentrations of at least about 50% or about 75% by weight, calculated to total weights of the shale inhibition additives. The methods disclosed herein further comprising loading or adding the hydrophobic amine-based shale inhibition agents into the shale inhibition additives of the wellbore fluids prior to circulating, providing and/or disposing the wellbore fluids in the wellbores such that the concentrations of triamine-based shale inhibition agents are at least about 50% or at least about 75% by weight, calculated to the total weights of the shale inhibition additives.

Further, the methods disclosed herein may maintain the concentrations of the triamine-based shale inhibition agents at about 50% or more by weight, calculated to the total weights of the shale inhibition additives, during a first or initial circulation of the present wellbore fluids in the wellbores and/or one or more subsequent second circulations of the present wellbore fluids in the wellbores. The methods disclosed herein may recover or remove the present wellbore fluids from the wellbores after the first or initial circulation and/or the one or more subsequent second circulations of the wellbore fluids in the wellbores. Still further, the methods disclosed herein may maintain the concentrations of the triamine-based shale inhibition agents by adding or loading additional shale inhibition additives, additional hydrophobic amine-based shale inhibition agents, and/or additional triamine-based shale inhibition agents into the present wellbore fluids after the initial or first circulation and/or before the one or more subsequent second circulations of the wellbore fluids in the wellbores. As a result, the methods disclosed herein may reduce the swelling of shales in the wellbores during the initial or first circulations and the one or more subsequent second circulations of the present wellbore fluids during portions of or across entire wellbore drilling operations.

In one or more embodiments, the present inhibition additives comprising blends of the amine-based inhibition agents disclosed herein are usable as efficient and/or effective shale inhibitors. Ratios of the hydrophobic amine-based shale inhibition agents to the oligomeric amine-based shale inhibition agents in accordance with the present disclosure are from about 1:1 and up to about 5:1 or about 10:1. In some embodiments, the triamine-based inhibition agents disclosed herein are present at concentrations of at least about 50% or at least about 75% by weight, calculated to the total weights of the derivatized amine.

### EXAMPLES

In the following examples, a series of experiments were conducted to illustrate the performance of derivatized amines as shale inhibitors in accordance with the present disclosure. Amines were derivatized and tested as inhibitors versus their parent underivatized compound in water-based drilling fluid with pH ranging from 8.5 to 11 to cover the most plausible range of pH that the WBM will operate under.

### Example 1

Details of a wellbore fluid formulation utilized to test one or more blends of amines as shale inhibitors are shown below in Table 1.

TABLE 1

| | |
|---|---|
| 1% NaCl | 296.05 |
| Inhibitor | 10.00 |
| encapsulator polymer | 1.00 |
| cellulose derivative | 2.00 |
| xanthan | 1.25 |
| anti-accretion additive | 7.00 |
| API Clay | 15.00 |
| barite | 129.9 |
| Vol, mL | 350 |
| Mw, ppg | 11.00 |

The formulation set forth in Table 1 was blended, ARNE clay (hereinafter “the clay”) was then added to the blend to form a mixture, and the mixture was rolled in an oven for 16 hours. For this example, the clay comprised of clay chunks from about 4 millimeters (hereinafter “mm”) to about 6 mm which is typical for the type of testing in Example 1. The clay utilized in subsequent examples for bulk hardness test.

Examples of amines used in Example 1 includes: Baxxodur EC210, Baxxodur EC201, Berolamine BA-20, HMD (Flexatram DAM 700, DAM800), DCH (Flexatram DAM 950), Tertamethyl-HMD, Dytek A, Dytek EP, DMAPA, etheramine D230, Vestamin PACM, Vestamin TMD, 1,8-diaminooctane, 2,2″-(ethylenedioxy)bis(ethylamine), and 7,7-10-trioxa-1,13-tridecanediamine. The list is not all-inclusive but shows examples if structurally different amines that were evaluated to determine the best shale inhibitor.

The clay was subsequently removed by filtration and bulk hardness test was done. The procedure steps are typical for the present industry. Results of the screening are shown in FIG. 1 using formulations listed in Table 1 and the example amines listed above. Values are in torque in-lbs and are recoded as number of turns on a bulk hardness meter to go from 20 to 80. Lower values are better, because higher torque values on the bulk hardness meter indicates that the shale is harder and is more inhibited.

Additional analysis of structure-activity is shown in FIG. 2. Taken the series of ether amines and ranking them by performance as shown in FIG. 2, it is clear that more hydrophobic amines perform better (higher torque in bulk hardness meter). However, there are limitations to hydrophobicity of amines because at some point the amines do not dissolve in water and their performance as shale inhibitor suffers. For example, logically 1,12-diaminododecane should perform better than 1,8-diaminooctane but because of solubility issues that is not the case. Etheramine D230 is shown as the best performing etheramine. However, this can be further improved by some adjustment in hydrophobicity by replacing propylene oxide with butylene oxide. Example of such product would be Jeffamine D-205.

Furthermore, amines produced from condensation of a diol with acrylonitrile followed by hydrogenation can also be optimized for good performance. In FIG. 2, we see that 4,9-dioxa-1,12-dodecanediamine works better than either 7,7,10-trioxa-1,13-tridecanediamine or 2,2″-(ethylenedioxy)bis(etheramine). This is because 4,9-dioxa-1,12-dodecanediamine is more hydrophobic than the other two amines because it has a butanediol moiety in the middle. Further elaboration of this approach suggests that an etheramine based on 1,6-hexanediol+acrylonitrile+hydrogenation will perform even better. Further modifications to other diols to improve hydrophobicity (for example. etheramine based on 1,8-octanediol) will work even better as shale inhibition until the product stops dissolving in water.

FIG. 3 shows minimal rheological differences. However, 10% acetylated PEI shows a lower value for the number of turns, which means the cuttings became harder, which is an improvement over the control untreated PEI. The increasing degree of acetylation reduced the clay's hardness, which indicates that it is possible to over derivatize the material. Over derivatization reduces the number of free amines available. possibly preventing the amine from binding to clay by a cation exchange mechanism. FIG. 3 shows that 10% and 30% acetylation is an improvement over the baseline, but 50% is worse. The percent moisture is similar in the control and 10%, 30% acylated PEI but is worse for 50% acetylated PEI. Derivatization to a different degree with acetic acid is shown. In addition, derivatization with propionic anhydride or a fatty acid or acyl chloride will follow a similar process.

FIG. 4 shows results for PEI derivatized with longer alkyl chains using different anhydrides (butyric, hexanoic) versus acetic in FIG. 3. Comparing results for PEI derivatized at 10 mol % shows that butyric and hexanoic derivatives give similar rheology at 120° F. Still, bulk hardness is better (fewer turns to reach the target value, indicating harder, more inhibited shale), and moisture content is lower than acetic anhydride. It is clear from this series that by increasing hydrophobicity of the alkyl chains and controlling the degree of derivatization, it is possible to improve the performance of PEI to use it as a shale inhibitor.

Foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

1. A method of formulating a shale inhibitor comprising a polyamine of a Formula (I): 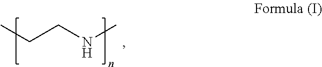
wherein n is a polymer of repeating units comprising an amine group and two carbon aliphatic CH₂CH₂ spacers;
treating Formula (I) with at least one acid anhydride, and/or at least one organic acid, and/or at least one acyl chloride;
thereby producing a derivatized amine shale inhibitor.

2. The method of claim 1, wherein the at least one anhydride is added dropwise to Formula (I) in a flask at ambient temperature to produce a reaction; wherein further the reaction is neutralized.

3. The method of claim 1, wherein the at least one organic acid is added dropwise to Formula (I) in a flask at temperatures between 80° C.-150° C. to produce a reaction; wherein further the reaction is neutralized.

4. The method of claim 1, wherein the at least one acyl chloride is added dropwise to Formula (I) in a flask at ambient temperature to produce a reaction; wherein further the reaction is neutralized.

5. The method of claim 1, wherein the polyamine comprises one or more diamines, one or more triamines, one or more polyamines, and/or mixtures thereof; wherein the polyamine comprises one or more linear molecules, one or more non-linear or branched molecules, or mixtures thereof.

6. (canceled)

7. The method of claim 1, wherein n is an integer from 2-100.

8. The method of claim 1 wherein the at least one acid anhydride comprises at least one of acetic anhydride, propionic anhydride, and at least one mixture thereof; wherein the acid anhydride further comprises a cyclic anhydride of at least one of succinic anhydride, maleic anhydride, phthalic anhydride, or glutaric anhydride.

9. (canceled)

10. The method of claim 8, wherein the cyclic anhydride produces a reaction product having amide bonds and pendant acid groups; wherein the reaction product is utilized as both a shale inhibitor and shale encapsulator.

11. (canceled)

12. The method of claim 1, wherein the at least one organic acid comprises at least one carbon atom to fifty four carbon atoms; wherein the at least one organic acid comprises carboxylic acids, aliphatic acids, aromatic acids, or at least one mixture thereof.

13. (canceled)

14. The method of claim 1, wherein one or more polyamines are derivatized to at least 10 mol % derivatized, at least 30 mol % derivatized, or up to 50 mol % derivatized; wherein the polyamine is methylated using alkylating agents.

15. (canceled)

16. The method of claim 14, wherein the alkylating agents comprises methyl chloride and/or methyl sulfate.

17. The method of claim 14, wherein the polyamine is methylated with at least one Eschweiler-Clarke methylation or reaction.

18. The method of claim 14, wherein the polyamine is methylated by reacting the polyamine with a mixture of formaldehyde and formic acid.

19. The method of claim 1, wherein the derivatize amine shale inhibitor is used to treat a subterranean formation in a wellbore to prevent reactive shale swelling.

20. A wellbore fluid, comprising:
a base fluid;
a shale inhibitor comprising:
a polyamine of a Formula (I): 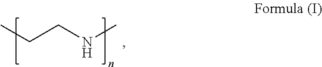
wherein n is a polymer of repeating units comprising an amine group and two carbon aliphatic CH₂CH₂ spacers;
treating Formula (I) with at least one acid anhydride, and/or at least one organic acid, and/or at least one acyl chloride.

21. The wellbore fluid of claim 20, wherein the base fluid is an aqueous base fluid comprising acid anhydride, organic acid, and/or acyl chloride.

22. The wellbore fluid of claim 20, wherein the polyamine comprises one or more diamines, one or more triamines, one or more polyamines, and/or mixtures thereof.

23. The wellbore fluid method of claim 20, wherein the polyamine comprises one or more linear molecules, one or more non-linear or branched molecules, or mixtures thereof.

24. The wellbore fluid method of claim 20, wherein n is an integer from 2-100.

25. The wellbore fluid method of claim 20, wherein the at least one acid anhydride comprises at least one of acetic anhydride, propionic anhydride, and at least one mixture thereof; wherein the acid anhydride further comprises a cyclic anhydride of at least one of succinic anhydride, maleic anhydride, phthalic anhydride, or glutaric anhydride.

26. (canceled)

27. The wellbore fluid method of claim 25, wherein the cyclic anhydride produces a reaction product having amide bonds and pendant acid groups.
